(19) United States
(12) Patent Application Publication
(10) Pub. No.: US 2020/0371216 A1
(43) Pub. Date: Nov. 26, 2020

(54) INTEGRATED CIRCUIT AND SYSTEM FOR MEASURING DISTANCE

(71) Applicant: SZ DJI TECHNOLOGY CO., LTD., Shenzhen (CN)

(72) Inventors: Xiang LIU, Shenzhen (CN); Xiaoping HONG, Shenzhen (CN)

(21) Appl. No.: 16/990,534

(22) Filed: Aug. 11, 2020

Related U.S. Application Data
(63) Continuation of application No. PCT/CN2018/076307, filed on Feb. 11, 2018.

(51) Int. Cl. G01S 7/4861; G01S 17/08

(52) U.S. Cl. CPC G01S 7/4861; G01S 17/08

(57) ABSTRACT

An integrated circuit includes a transmitter, a signal input channel, a signal sampling circuit, and an analog-to-digital conversion circuit. The transmitter is configured to transmit a ranging signal. The signal input channel is configured to transmit an analog electrical signal corresponding to an echo signal of the ranging signal. The signal sampling circuit includes a switched capacitor array and is configured to sample the analog electrical signal and store a sampled signal of the analog electrical signal. The analog-to-digital conversion circuit is configured to perform analog-to-digital conversion on the sampled signal stored in the signal sampling circuit to generate a digital electrical signal indicating reception time of the echo signal.

### CROSS-REFERENCE TO RELATED APPLICATION

This application is a continuation of International Application No. PCT/CN2018/076307, filed Feb. 11, 2018, the entire content of which is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure generally relates to the signal ranging technology field and, more particularly, to an integrated circuit and a system for measuring distance.

### BACKGROUND

With the development of the technology, besides the existing method of sensing the external environment in a 2-dimensional manner, 3-dimensional information of the external environment is also desired by people.

With the signal ranging technology, the distance to a measured object may be conveniently calculated based on flight time or phase change during a flight of a ranging signal. Therefore, the signal ranging technology is widely applied in various systems that need to sense the environment, such as an unmanned aerial vehicle (UAV) system, an unmanned vehicle system, etc.

After hitting the measured object, the ranging signal is reflected to form an echo signal. To ensure ranging accuracy, a ranging system may use a higher frequency to perform sampling and analog-to-digital conversion on the echo signal. Take common laser ranging as an example, the sampling frequency and analog-to-digital conversion frequency of the echo signal of the laser signal need to be maintained at the GHz level. The ranging system uses an analog-to-digital conversion circuit to perform the analog-to-digital conversion. If the analog-to-digital conversion circuit needs to maintain the higher analog-to-digital conversion frequency and the higher analog-to-digital conversion accuracy, the power consumption and cost of the analog-to-digital conversion circuit are increased.

### SUMMARY

Embodiments of the present disclosure provide an integrated circuit including a transmitter, a signal input channel, a signal sampling circuit, and an analog-to-digital conversion circuit. The transmitter is configured to transmit a ranging signal. The signal input channel is configured to transmit an analog electrical signal corresponding to an echo signal of the ranging signal. The signal sampling circuit includes a switched capacitor array and is configured to sample the analog electrical signal and store a sampled signal of the analog electrical signal. The analog-to-digital conversion circuit is configured to perform analog-to-digital conversion on the sampled signal stored in the signal sampling circuit to generate a digital electrical signal indicating reception time of the echo signal.

Embodiments of the present disclosure provide a system for measuring distance, including an integrated circuit, a receiver, and a controller. The integrated circuit includes a transmitter, a signal input channel, a signal sampling circuit, and an analog-to-digital conversion circuit. The transmitter is configured to transmit a ranging signal. The signal input channel is configured to transmit an analog electrical signal corresponding to an echo signal of the ranging signal. The signal sampling circuit includes a switched capacitor array and is configured to sample the analog electrical signal and store a sampled signal of the analog electrical signal. The analog-to-digital conversion circuit is configured to perform analog-to-digital conversion on the sampled signal stored in the signal sampling circuit to generate a digital electrical signal indicating reception time of the echo signal. The receiver is configured to receive the echo signal corresponding to the ranging signal. The controller is configured to, after the transmitter transmits the ranging signal, transmit a control signal to the signal sampling circuit to control the signal sampling circuit to operate to obtain the sampled signal.

### BRIEF DESCRIPTION OF THE DRAWINGS

FIG. 1 illustrates a schematic structural diagram of an integrated circuit according to some embodiments of the present disclosure.

FIG. 2 illustrates a schematic structural diagram of a signal sampling circuit based on a switched capacitor array according to some embodiments of the present disclosure.

FIG. 3 illustrates a schematic diagram showing a voltage waveform of an analog electrical signal according to some embodiments of the present disclosure.

FIG. 4 illustrates a schematic structural diagram of a signal sampling circuit based on a switched capacitor array according to some other embodiments of the present disclosure.

FIG. 5 illustrates a schematic structural diagram of an analog-to-digital conversion circuit according to some embodiments of the present disclosure.

FIG. 6 illustrates a schematic diagram showing a voltage waveform of a sampling signal corresponding to the analog electrical signal shown in FIG. 3.

FIG. 7 illustrates a schematic diagram showing a cascade connection of a plurality of sub-switch capacitor arrays according to some embodiments of the present disclosure.

FIG. 8 illustrates a schematic structural diagram of a system for measuring distance according to some embodiments of the present disclosure.

FIG. 9 illustrates a schematic structural diagram of a system for measuring distance according to some other embodiments of the present disclosure.

FIG. 10 illustrates a schematic diagram showing an echo signal according to some embodiments of the present disclosure.

### DETAILED DESCRIPTION OF THE EMBODIMENTS

The present disclosure does not limit a type of a ranging signal, which may include an infrared signal or a laser signal.

To facilitate understanding, a ranging manner of the ranging signal is introduced as follows.

First, a transmitter transmits the ranging signal. The ranging signal is reflected by a measured object (e.g., an obstacle) to form an echo signal. After the echo signal is received by a receiver (e.g., a photoelectric converter, such as a photodiode, a photomultiplier tube, etc.), the echo signal may be power-amplified to form an analog electrical signal (the analog electrical signal may be used to represent the echo signal) corresponding to the echo signal. In some embodiments, the echo signal may not be power-amplified, and the signal received by the receiver is directly used as the analog electrical signal corresponding to the echo signal.

Then, a signal sampling circuit may be used to sample the analog electrical signal to obtain a sampled signal of the analog electrical signal. An analog-to-digital conversion circuit is used to perform the analog-to-digital conversion on the sampled signal to obtain a digital signal. The digital signal may be used to indicate the reception time of the echo signal, or used to calculate the reception time of the echo signal.

After the reception time of the echo signal (also referred to as “return time of the echo signal”) is calculated, the distance to the measured object can be calculated based on a difference between transmission time of the ranging signal and the reception time of the echo signal.

A technical solution of the present disclosure is described in connection with drawings as follows.

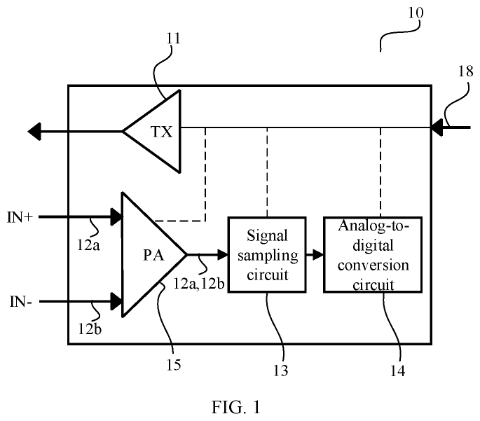

As shown in FIG. 1, an integrated circuit 10 is provided by embodiments of the present disclosure. The integrated circuit 10 includes a transmitter 11, signal input channels 12a and 12b, a signal sampling circuit 13 based on a switched capacitor array, and an analog-to-digital conversion circuit 14.

The transmitter 11 may be configured to transmit the ranging signal. The ranging signal may include, for example, an infrared signal or a laser signal. In some embodiments, the ranging signal includes the infrared signal, and the transmitter 11 may include, for example, an infrared diode. In some other embodiments, the ranging signal includes the laser signal, and the transmitter 11 may include, for example, a laser diode.

The signal input channels 12a and 12b are coupled to an external receiver (not shown in FIG. 1). The receiver may be configured to receive the echo signal of the ranging signal. The receiver may include, for example, a photoelectric conversion device, such as a photodiode, a photomultiplier tube, an avalanche photodiode (APD), etc. The signal input channels 12a and 12b may be configured to transmit a signal received by the receiver to the signal sampling circuit 13. In some embodiments, the signal input channels 12a and 12b may be configured to transmit the signal received by the receiver to the signal sampling circuit 13 after proper processing (such as power amplification).

FIG. 1 shows an example of a dual signal input channel (including a first signal input channel 12a and a second signal input channel 12b). In the implementation of the dual signal input channel, the analog electrical signal corresponding to the echo signal of the present disclosure may include a differential signal of signals in the two signal input channels 12a and 12b. A signal with smaller power may be better recognized by using a signal transmission manner based on the differential signal. Moreover, the differential signal includes a higher signal-to-noise ratio, thus external noise may not easily affect the differential signal.

However, embodiments of the present disclosure are not limited to the dual signal input channel shown in FIG. 1. In some embodiments, a single signal input channel may be used. In the implementation including the single signal input channel, the analog electrical signal corresponding to the echo signal of the present disclosure may be defined by a potential difference between a voltage of a signal in the single signal input channel and ground.

In some embodiments, a power amplifier 15 may be coupled to the signal input channels 12a and 12b. In some embodiments, the analog electrical signal corresponding to the echo signal of the present disclosure may include a signal amplified by the power amplifier 15. The ranging accuracy of the system may be improved by power-amplifying the echo signal received by the receiver.

In some embodiments, no power amplifier is coupled to the signal input channels 12a and 12b. An output signal of the receiver may be directly transmitted to the signal sampling circuit 13. This simplifies circuit implementation.

The signal sampling circuit 13 is the signal sampling circuit based on a switched capacitor array. The signal sampling circuit 13 is configured to perform sampling on the analog electrical signal input by the signal input channels 12a and 12b and store (or hold) the sampled signal of the analog electrical signal. The signal sampling circuit 13 may use the higher frequency (e.g., a sampling frequency at GHz level) to perform sampling on the analog electrical signal. An implementation manner of the signal sampling circuit 13 is described with examples in detail in connection with specific embodiments as follows and is not specified here.

The analog-to-digital conversion circuit 14 may be configured to perform analog-to-digital conversion on the sampled signal stored by the signal sampling circuit 13 to generate a corresponding digital electrical signal. The signal sampling circuit 13 includes the signal sampling circuit based on the switched capacitor array, which includes a signal storage function to store the sampled signal in the switched capacitor array.

Since the sampled signal may be stored in the switched capacitor array of the signal sampling circuit 13, the analog-to-digital conversion circuit 14 does not need to use an analog-to-digital conversion frequency consistent with the sampling frequency to perform the analog-to-digital conversion on the sampled signal in real-time. The analog-to-digital conversion frequency of the analog-to-digital conversion circuit 14 may be lower than (even much lower than) the sampling frequency of the signal sampling circuit 13. For example, the analog-to-digital conversion frequency of the analog-to-digital conversion circuit 14 may be set between several MHz and several tens of MHz.

The signal sampling circuit based on the switched capacitor array may use the switched capacitor array to store the sampled signal. Therefore, the analog-to-digital conversion circuit does not need to perform the analog-to-digital conversion on the sampled signal in real-time, which lowers the requirement of the system for a conversion rate of the analog-to-digital conversion circuit. As such, the cost and power consumption of the analog-to-digital conversion circuit are reduced. In some embodiments, the receiver, the signal sampling circuit, and the analog-to-digital conversion circuit are integrated into a same chip, which is beneficial to reduce the volume and cost of the system.

As shown in FIG. 1, the integrated circuit 10 further includes a control terminal 18. An external controller may input a control signal through the control terminal 18 to control components of the integrated circuit 10. For example, the transmitter 11 may be coupled to the control terminal 18, such that the external controller may control the transmission time of the ranging signal through the control terminal 18. As another example, the analog-to-digital conversion circuit 14 may be coupled to the control terminal 18, such that the external controller may control the analog-to-digital conversion frequency of the analog-to-digital conversion circuit 14 through the control terminal 18. As another example, the signal sampling circuit 13 may be coupled to the control terminal 18, such that the external controller may control on/off of a switched capacitor circuit of the signal sampling circuit 13, or delay time of a delay chain of the signal sampling circuit 13. As another example, the power amplifier 15 may be coupled to the control terminal 18, such that the external controller may control whether the power amplifier 15 starts operation or control a power magnification of the power amplifier 15.

In some embodiments, the above-described controller may be integrated in the integrated circuit 10 to improve system integration and reduce system volume.

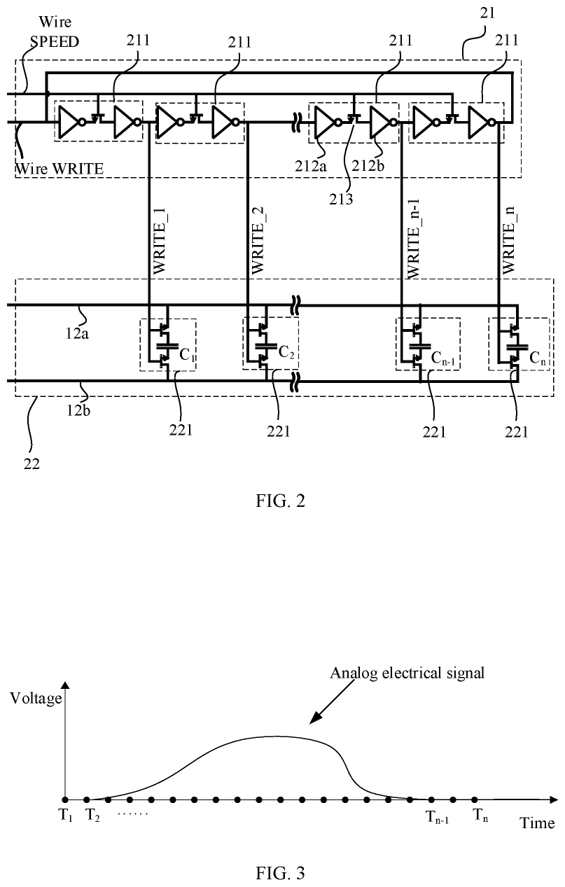

FIG. 2 shows an example of the signal sampling circuit 13. As shown in FIG. 2, the signal sampling circuit includes a delay chain 21 and a switched capacitor array 22. The delay chain 21 includes n delay circuits 211 (n is a positive integer greater than 1). The n delay circuits 211 transmit the control signal (i.e., a signal of WRITE line, which may also be referred to as a WRITE signal) in sequence. A specific value of n may be determined according to the range of the ranging system including the integrated circuit 10 (i.e., the maximum distance measured by the ranging system) and the delay time of the delay circuit 211. For example, n may be equal to (2L)/(cT_{gap}), where L denotes the range of the ranging system including the integrated circuit 10, T_{gap} denotes the delay time of the delay circuit 211, and c denotes the speed of light. For example, the range of the ranging system is 120 m, and the delay time of the delay circuit 211 is 0.2 ns, then the delay chain 21 at least needs 4000 delay circuits 211.

In some embodiments, the delay circuit 211 of the delay chain 21 may include a delay circuit with fixed delay time, or a delay circuit with an adjustable delay time. As shown in FIG. 2, the delay circuit 211 includes two inverters 212a and 212b, and a metal oxide semiconductor (MOS) transistor 213 between the two inverters 212a and 212b. The MOS transistor 213 may include an N-type MOS (NMOS) transistor or a P-type MOS (PMOS) transistor. The MOS transistor 213 and the delay circuit 211 form an RC delay circuit due to the impedance of the MOS transistor 213 and the parasitic capacitance of the delay circuit 211. Therefore, parameters of the RC delay circuit of the delay circuit 211 may be adjusted by adjusting the gate voltage (corresponding to the voltage at the SPEED line in FIG. 2) of the MOS transistor 213, so as to adjust the delay time.

The shorter the delay time of the delay circuit 211 is, the higher the sampling frequency of the signal sampling circuit 13 is. By introducing the delay circuit with the adjustable delay time, the sampling frequency of the signal sampling circuit 13 may be adjustable according to actual needs, such that the flexibility of the system is improved.

As shown in FIG. 2, the switched capacitor array 22 includes n switched capacitor circuits 221 corresponding to the n delay circuits 211, respectively. Each of the n switched capacitor circuits 221 is coupled to the signal input channels 12a and 12b. The switched capacitor circuit 221 may be configured to sample and store the signals of the signal input channels 12a and 12b when the control signal (a signal of the WRITE line) is transmitted to the delay circuit 211 corresponding to the switch capacitor circuit 221.

FIG. 2 shows a possible implementation of the switched capacitor circuit 221. As shown in FIG. 2, a first switched capacitor circuit 221 of the switched capacitor array 22 includes a capacitor C₁ and two MOS transistors at two terminals of the capacitor C₁, respectively. The gate of each of the two MOS transistors is coupled to the WRITE line and is configured to receive the control signal transmitted by the WRITE line. The source and drain of the MOS transistor above the capacitor C₁ are coupled to the signal input channel 12a and one terminal of the capacitor C₁, respectively. The source and drain of the MOS transistor under the capacitor C₁ are coupled to the other terminal of the capacitor C₁ and the signal input channel 12b, respectively.

Before the signal sampling circuit 13 starts to operate, the voltages of the output terminals (i.e., WRITE_1 to WRITE_n shown in FIG. 2) of the delay circuits 211 of the delay chain 21 are low (e.g., a low-level voltage signal). The MOS transistors of the switched capacitor circuit 221 corresponding to each of the delay circuits 211 is off.

To prepare for the sampling, the control signal (e.g., a high-level voltage signal) is first input to the WRITE line, such that the control signal may be transmitted along the delay chain 21. Assume that the delay time of each delay circuit is T, and the time to transmit the signal to an i-th delay circuit is Tᵢ (i is a positive integer and ranges from 1 to n). Thus, at time T₁, the control signal is transmitted to the output terminal of the first delay circuit to cause the voltage of WRITE_1 to change from low level to high level. The MOS transistor of the first switched capacitor circuit is turned on. The capacitor C₁ samples and stores the voltage values of the signals of the signal input channels 12a and 12b at time T₁. Then, at time T₂, the control signal of the delay chain 21 is transmitted to the output terminal of the second delay circuit 211 to cause the voltage of WRITE_2 to change from low level to high level. The MOS transistor of the second switched capacitor circuit is turned on. The capacitor C₂ samples and stores the voltage values of the signals in the signal input channels 12a and 12b. As the control signal continues to propagate along the delay chain 21, after every time interval T, the switched capacitor array 22 may sample and store the signals in the signal input channels 12a and 12b once. When the time Tₙ is reached, the signals of the signal input channels 12a and 12b during the period of T₁-Tₙ are sampled and stored in the capacitors C₁-Cₙ.

FIG. 3 illustrates an example of a voltage waveform of the analog electrical signal during the period of T₁-Tₙ. After the above-described sampling process, the voltage value corresponding to Tᵢ is stored in the capacitor Cᵢ of the i-th switched capacitor circuit.

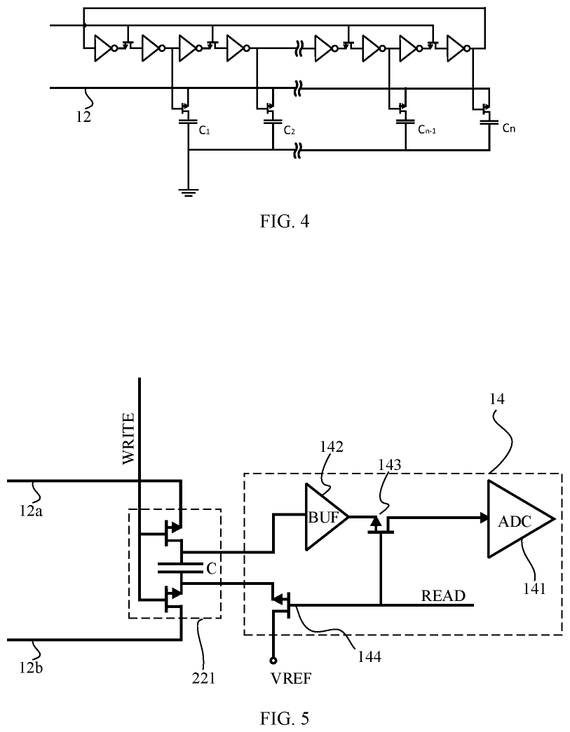

The above describes an example that the integrated circuit 10 includes the dual signal input channel including signal input channels 12a and 12b. The analog electrical signal corresponding to the echo signal includes the differential signal of the signals transmitted in the dual signal input channel including signal input channels 12a and 12b. However, embodiments of the present disclosure are not limited to this. FIG. 4 shows another example of the integrated circuit 10, which only includes a single signal input channel 12. An analog electrical signal corresponding to the echo signal may be determined by a potential difference between the singe signal input channel 12 and ground.

The analog-to-digital conversion circuit 14 may be implemented in one of various manners. FIG. 5 shows an example of the analog-to-digital conversion circuit 14.

As shown in FIG. 5, the analog-to-digital conversion circuit 14 includes an analog-to-digital converter (ADC) 141, a buffer 142, a first MOS transistor 143, and a second MOS transistor 144.

In operation, a signal READ (e.g., the signal READ may be a high-level voltage signal) may be transmitted to the analog-to-digital conversion circuit 14 by the external controller to turn on the first MOS transistor 143 and the second MOS transistor 144. As such, the signal (e.g., voltage signal) stored in the capacitor C may be output to the ADC 141 through the buffer 142. According to this manner, the ADC 141 may read the signals stored in the switched capacitor circuits of the switched capacitor array in sequence to complete the analog-to-digital conversion of the signals. Since the signals are stored in the signal sampling circuit 13, no real-time processing is needed. Therefore, the ADC 141 may use a lower analog-to-digital conversion frequency (e.g., maybe from several kHz to several hundreds of MHz) to read the signal and perform the analog-to-digital conversion.

As shown in FIG. 5, the connection manner of the terminal VREF of the second MOS transistor 144 is related to the types of the signal input channel and the ADC 141. If the signal input channel includes the single signal input channel, correspondingly, the ADC 141 includes an ADC 141 having a single terminal input, and the terminal VREF may thus be coupled to the ground. If the signal input channel includes a dual signal input channel (configured to input the differential signal), correspondingly, the ADC 141 includes the ADC 141 having differential inputs. The differential input terminals of the ADC 141 are coupled to one terminal of the first MOS transistor 143 (as shown in FIG. 5) and the terminal VREF of the second MOS transistor 144.

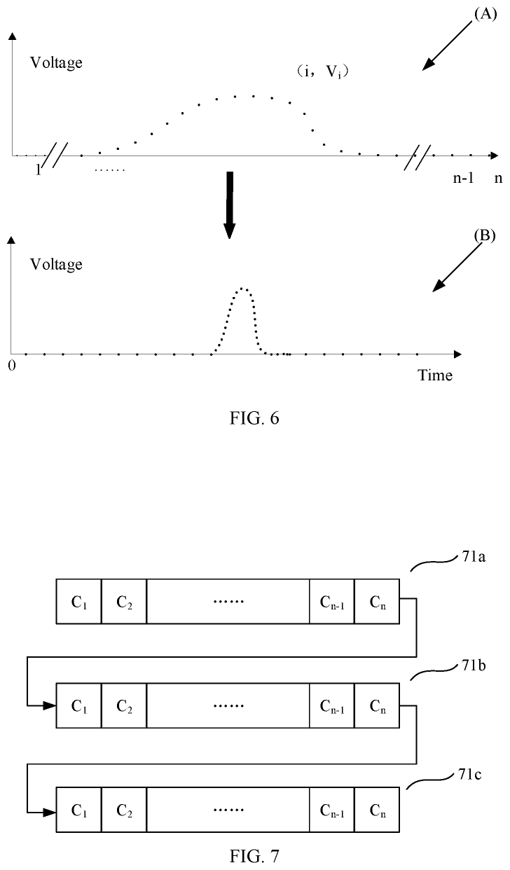

The waveform of the sampled signal as the voltage waveform shown in FIG. 3 is taken as an example. The voltage waveform of the sampled signal is discretized by the signal sampling circuit 13 to be in the form shown in part A of FIG. 6. In part A of FIG. 6, i indicates an i-th switched capacitor circuit of the switched capacitor array, and Vi indicates the voltage value of the signal stored in the i-th switched capacitor circuit. (i, Vᵢ) corresponds to (Tᵢ, Vᵢ) in FIG. 3. Part A of FIG. 6 shows the voltage waveform of the sampled signal by using the numbering of the sampling points as the horizontal axis. In reality, the sampling process of the analog electrical signal is usually short. The waveform is usually a small pulse signal in the time domain, as shown in part B of FIG. 6.

In some embodiments of the present disclosure, the above-described signal sampling circuit 13 includes the signal sampling circuit based on the switched capacitor array. However, embodiments of the present disclosure do not limit the composition of the switched capacitor array of the signal sampling circuit 13. The signal sampling circuit 13 may only include one switched capacitor array, or a plurality of sub switched capacitor arrays cascaded together (such as end to end connected in sequence).

As shown in FIG. 7, the signal sampling circuit 13 includes three switched capacitor sub-arrays 71a, 71b, and 71c cascaded together. Each of the switched capacitor sub-arrays includes n switched capacitor circuits (each of C1, C2, Cn−1, Cn, etc., in FIG. 7 corresponds to one switched capacitor circuit). When only the n switched capacitor circuits are needed to satisfy the system needs, the switched capacitor sub-array 71a may be controlled to operate, and the other switched capacitor sub-arrays 71b and 71c do not operate. When more switched capacitor circuits are needed to satisfy the system needs, the switched capacitor sub-arrays 71a and 71b may be controlled to operate simultaneously, or even the switched capacitor sub-arrays 71a, 71b, and 71c may be controlled to operate simultaneously.

In some embodiments of the present disclosure, a cascade solution of the plurality of switched capacitor sub-arrays is provided. A quantity of the switched capacitor circuits of the switched capacitor array may be adjusted according to actual needs, such that the sampling manner of the signal sampling capacitor is more flexible. A plurality of manners may be used to adjust the cascade connection manner of the plurality of switched capacitor sub-arrays. For example, the cascade connection may be adjusted manually. In some embodiments, a switch may be arranged at the cascade position of the adjacent switched capacitor sub-arrays, and is controlled to be on/off through the external controller. As such, the number of the switched capacitor sub-arrays cascaded together may be adjusted in real-time.

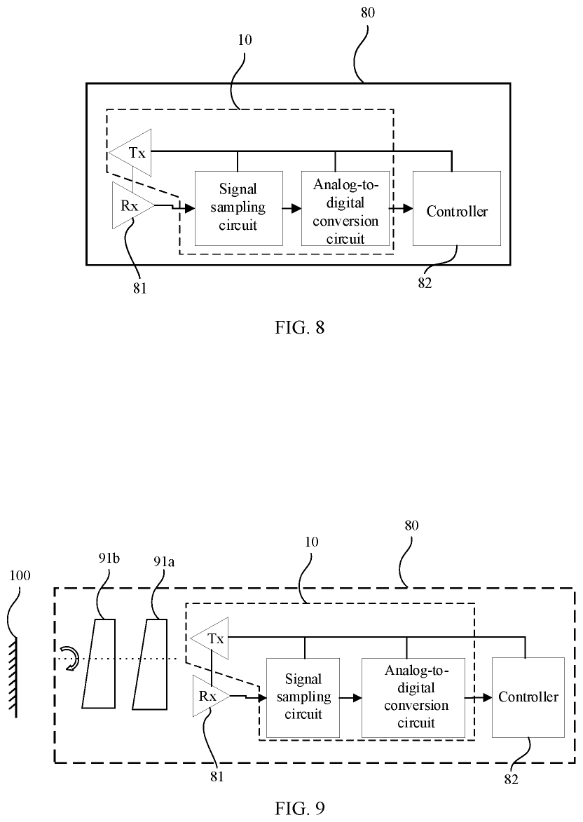

As shown in FIG. 8, embodiments of the present disclosure also provide a system 80 for measuring distance (distance measurement system). The system 80 includes, for example, a light detection and ranging (LiDAR) system. The system 80 also includes the integrated circuit 10 described in any of the above embodiments, a receiver 81, and a controller 82.

The receiver 81 may be configured to receive the echo signal corresponding to the ranging signal. The receiver 81 may include a photoelectric conversion device, such as a photodiode, a photomultiplier tube, an APD, etc.

After the transmitter of the integrated circuit 10 transmits the ranging signal, the controller 82 may transmit the control signal to the signal sampling circuit of the integrated circuit 10 to control the signal sampling circuit to operate to obtain the sampled signal. The controller 82 may include a central controller, or distributed controller, and is not limited by embodiments of the present disclosure.

In some embodiments, the controller 82 may be further configured to control the transmitter to transmit the ranging signal.

In some embodiments, the controller 82 may be further configured to control the analog-to-digital conversion circuit of the integrated circuit 10 to perform analog-to-digital conversion on the sampled signal.

In some embodiments, as shown in FIG. 9, the system 80 further includes optical systems 91a and 91b corresponding to the transmitter, and optical systems 91a and 91b corresponding to the receiver 81. The optical systems 91a and 91b corresponding to the transmitter are configured to adjust the transmission angle of the ranging signal. The optical systems 91a and 91b corresponding to the receiver 81 are configured to adjust the reception angle of the echo signal corresponding to the ranging signal. The controller 82 may be further configured to control the optical systems 91a and 91b corresponding to the transmitter 11 and the optical systems 91a and 91b corresponding to the receiver 81, such that the ranging signal can be used to detect the measured object at different angles.

In the example shown in FIG. 9, the optical systems corresponding to the transmitter and the optical systems corresponding to the receiver include the same optical systems. The disclosure is not limited thereto. The optical systems corresponding to the transmitter and the optical systems corresponding to the receiver may also include different optical systems.

In the example shown in FIG. 9, the optical systems 91a and 91b include rotatable dual prisms. The disclosure is not limited thereto. For example, the optical systems 91a and 91b may be replaced by a micro-electro-mechanical system (MEMS) galvanometer, or other types of optical components that may adjust an optical path of the ranging signal.

The ranging manner of the system 80 is described below using a LiDAR system as the example of the system 80.

As shown in FIG. 9, the system 80 transmits a laser pulse signal to the measured object 100 through the transmitter Tx, and receives the echo signal of the laser pulse signal through the receiver Rx to generate the corresponding analog electrical signal. After the analog electrical signal corresponding to the echo signal is obtained, the analog electrical signal may be sampled by using the signal sampling circuit with a higher frequency, and the sampled signal is stored in the switched capacitor array of the signal sampling circuit. Then, the analog-to-digital conversion circuit with low speed and high accuracy is configured to perform the analog-to-digital conversion on the sampled signal stored in the switched capacitor array to obtain the voltage waveform of the analog electrical signal corresponding to the echo signal. The return time of the echo signal is calculated according to the voltage waveform to calculate the distance to the measured object 100.

In some embodiments, the system 80 may be configured to perform detection on the measured object 100 as follows.

First, the controller 82 can control the transmitter to transmit the laser pulse signal (corresponding to the ranging signal described above). While the transmitter is transmitting the laser pulse signal, the controller 82 can control the delay chain to transmit the control signal, causing the switched capacitor circuit of the signal sampling circuit to operate to store the sampled signal.

The length n of the delay chain or the number n of the switched capacitor circuits of the switched capacitor array may be determined by the range of the system 80 (i.e., the maximal distance that can be measured by the system 80) and the delay time of each of the delay circuits of the delay chain. For example, n may be equal to (2L)/(cT_{gap}), where L denotes the range of the system 80 including the integrated circuit 10, T_{gap} denotes the delay time of the delay circuit, and c denotes the speed of light. For example, the range of the ranging system is 120 m, and the delay time of the delay circuit is 0.2 ns, then the delay chain at least needs 4000 delay circuits.

After the laser pulse signal is reflected by the measured object, the receiver 81 can receive the echo signal to form the analog electrical signal corresponding to the echo signal. The analog electrical signal is sampled and stored by the switched capacitor array of the signal sampling circuit.

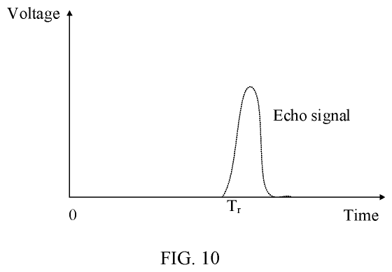

Assume that the switched capacitor array uses a sampling frequency of 5 GHz to sample and store the analog electrical signal, then for every T_{gap}=1 s/5 GHz=0.2 ns, the sampling is performed once, and 4000 sampled points may be obtained. As shown in FIG. 10, 0 of the time axis indicates the transmission time of the laser pulse signal. Tᵣ indicates the return time of the echo signal, and the distance to the measured object may be subsequently calculated and obtained according to Tᵣ.

Then, the controller 82 can control the analog-to-digital conversion circuit to read the sampled signal stored in the switched capacitor array with a frequency of 100 Mhz. The time for reading a sampled point to perform the analog-to-digital conversion is about 1 s/100 Mhz=10 ns. Therefore, the time needed for reading 4000 sampled points is about 40 μs.

Then, the controller 82 can determine the waveform of the analog electrical signal corresponding to the echo signal received by the receiver according to the 4000 sampled points. The controller 82 can also calculate the time difference Tᵣ of the laser pulse signal from being transmitted until being received by the receiver 81 and calculate the distance to the measured object 100 according to Tᵣ.

The above-described embodiments can be implemented in whole or part by software, hardware, firmware, or any other combination. When being implemented using software, the flows and functions may be implemented in whole or part in the form of a computer program product. The computer program product includes one or more computer instructions. When the computer program instructions are loaded and executed on the computer, all or a part of the flows or functions are generated according to embodiments of the present disclosure. The computer may include a general-purpose computer, a dedicated computer, a computer network, or other programmable devices. The computer instructions may be stored in a computer-readable storage medium or transmitted from one computer-readable storage medium to another computer-readable storage medium. For example, the computer instructions may be transmitted from a website site, computer, server, or data center to another website, computer, server, or data center through a wired manner (such as coaxial cable, optical fiber, digital subscriber line (DSL)) or a wireless manner (such as infrared, wireless, microwave, etc.). The computer-readable storage medium may include any available medium that can be accessed by a computer or a data storage device including a server, a data center, etc., integrated with one or more available media. The available medium may include magnetic medium (e.g., floppy disk, hard disk, magnetic tape), optical medium (e.g., digital video disc (DVD)), or semiconductor medium (e.g., solid-state disk (SSD)), etc.

Those of ordinary skill in the art should understand that, in combination with the units and processes of algorithms, the functions may be implemented by electronic hardware or combinations of computer software and electronic hardware. The specific applications and design requirements of the technical solution determine whether the functions are implemented by hardware or software. Those of skill in the art may apply different methods to each of the specific applications to implement the described functions. However, the implementation should not be considered to be outside the scope of the present disclosure.

In embodiments of the present disclosure, the above-described system, device, and method may be implemented in other manners. For example, the above-described device embodiments are merely exemplary. For example, the division of the units is only a logical function division, and the actual implementation may be according to another division method. For example, a plurality of units or components can be combined or integrated into another system, or some features can be omitted or not be executed. Further, the displayed or discussed mutual coupling or direct coupling or communicative connection can be through some interfaces, the indirect coupling or communicative connection of the devices or units can be electronically, mechanically, or in other forms.

The units described as separate components may be or may not be physically separated, the components displayed as units may be or may not be physical units, which can be in one place or be distributed to a plurality of network units. Some or all of the units can be chosen to implement the purpose of the embodiment according to the actual needs.

In the embodiment of the disclosure, individual functional units can be integrated into one processing unit, or can be individual units physically separated, or two or more units can be integrated into one unit.

Only specific embodiments of the present disclosure are described above. However, the scope of the present disclosure is not limited to the specific embodiments. Anyone of skill in the art should easily think of modifications or replacements within the disclosed scope. These modifications and replacements should be within the scope of the present disclosure. Therefore, the scope of the present invention should be subject to the scope of the claims.

What is claimed is:

1. An integrated circuit comprising:
a transmitter configured to transmit a ranging signal;
a signal input channel configured to transmit an analog electrical signal corresponding to an echo signal of the ranging signal;
a signal sampling circuit including a switched capacitor array and configured to sample the analog electrical signal and store a sampled signal of the analog electrical signal; and
an analog-to-digital conversion circuit configured to perform analog-to-digital conversion on the sampled signal stored in the signal sampling circuit to generate a digital electrical signal indicating reception time of the echo signal.

2. The integrated circuit of claim 1, wherein:
the signal input channel includes a first signal input channel and a second signal input channel; and
the analog electrical signal includes a differential signal of a signal input by the first signal input channel and a signal input by the second input channel.

3. The integrated circuit of claim 2, wherein:
the signal sampling circuit further includes a delay chain including n delay circuits configured to transmit a control signal in sequence, n being a positive integer greater than 1; and
the switched capacitor array includes n switched capacitor circuits corresponding to the n delay circuits, respectively, and coupled to the signal input channel, each of the n switched capacitor circuits being configured to sample and store the analog electric signal in response to the control signal reaches a corresponding one of the n delay circuits.

4. The integrated circuit of claim 3, wherein each of the n delay circuits includes two inverters and a metal oxide semiconductor (MOS) transistor coupled between the two invertors, and is configured to receive a voltage signal through a gate of the MOS transistor.

5. The integrated circuit of claim 4, wherein the MOS transistor includes a P-type MOS (PMOS) transistor or an N-type MOS (NMOS) transistor.

6. The integrated circuit of claim 1, wherein the switched capacitor array includes a plurality of switched capacitor sub-arrays that are cascaded.

7. The integrated circuit of claim 1, further comprising:
a power amplifier coupled to the signal input channel;
wherein the analog electrical signal includes a signal after being amplified by the power amplifier.

8. A system for measuring distance comprising:
an integrated circuit including:
a transmitter configured to transmit a ranging signal;
a signal input channel configured to transmit an analog electrical signal corresponding to an echo signal of the ranging signal to the signal sampling circuit;
a signal sampling circuit including a switched capacitor array and configured to sample the analog electrical signal and store a sampled signal of the analog electrical signal; and
an analog-to-digital conversion circuit, configured to perform analog-to-digital conversion on the sampled signal stored in the signal sampling circuit to generate a digital electrical signal indicating reception time of the echo signal;
a receiver configured to receive the echo signal corresponding to the ranging signal; and
a controller configured to, after the transmitter transmits the ranging signal, transmit a control signal to the signal sampling circuit to control the signal sampling circuit to operate to obtain the sampled signal.

9. The system of claim 8, wherein the controller is further configured to control the transmitter to transmit the ranging signal.

10. The system of claim 8, wherein the controller is further configured to control the analog-to-digital conversion circuit to perform the analog-to-digital conversion on the sampled signal.

11. The system of claim 8, further comprising:
a first optical system corresponding to the transmitter and configured to adjust a transmission angle of the ranging signal; and
a second optical system corresponding to the receiver and configured to adjust a reception angle of the echo signal;
wherein the controller is further configured to control the first optical system to adjust the transmission angle of the ranging signal and to control the second optical system to adjust the reception angle of the echo signal.

12. The system of claim 11, wherein each of the first optical system and the second optical system includes dual rotating prisms or micro-electro-mechanical system (MEMS) galvanometers.

13. The system of claim 8, further comprising:
an optical system corresponding to the transmitter and the receiver, and configured to adjust at least one of a transmission angle of the ranging signal or a reception angle of the echo signal;
wherein the controller is further configured to control the optical system to adjust at least one of the transmission angle of the ranging signal or the reception angle of the echo signal.

14. The system of claim 13, wherein the optical system includes dual rotating prisms or micro-electro-mechanical system (MEMS) galvanometers.

15. The system of claim 8, wherein the system includes a laser detection and ranging system.
